(19) United States
(12) Patent Application Publication
(10) Pub. No.: US 2025/0171709 A1
(43) Pub. Date: May 29, 2025

(54) METHODS OF USING SILICA-ZIRCONIA CATALYSTS IN A CONTINUOUS REACTOR

(71) Applicant: W.R. Grace & Co.-CONN., Columbia, MD (US)

(72) Inventors: Ignazio Catucci, Busto Garolfo, Milan (IT); Chelsea Leigh Grimes, Pasadena, CA (US); Cristian Libanati, Silver Spring, MD (US)

(21) Appl. No.: 18/840,317

(22) PCT Filed: Feb. 20, 2023
(86) PCT No.: PCT/US2023/013420

§ 371 Date: Aug. 21, 2024

Related U.S. Application Data
(60) Provisional application No. 63/312,328, filed on Feb. 21, 2022.

(51) Int. Cl. C11B 3/02; B01J 21/08; B01J 35/40; B01J 35/61; B01J 35/63

(52) U.S. Cl. CPC C11B 3/02; B01J 21/08; B01J 35/40; B01J 35/613; B01J 35/615; B01J 35/617; B01J 35/633; B01J 35/635; B01J 35/638

(57) ABSTRACT

A method includes contacting an initial composition comprising (i) a triglyceride and (ii) glycidol, a glycidyl ester, or both glycidol and a glycidyl ester with an effective amount of silica-zirconia catalyst in a continuous reactor. The methods are useful in producing a treated composition, e.g., a treated edible oil, having a reduced concentration of (ii) as compared to the initial composition.

### CROSS-REFERENCE TO RELATED APPLICATIONS

This application claims the benefit of priority to U.S. Provisional Application No. 63/312,328, filed Feb. 21, 2022, the contents of which are incorporated by reference herein in their entirety.

### TECHNICAL FIELD

The present disclosure is directed to methods comprising contacting an initial composition comprising (i) a triglyceride and (ii) glycidol, a glycidyl ester, or both glycidol and a glycidyl ester with an effective amount of silica-zirconia catalyst in a continuous reactor. The methods are useful in producing a treated composition, e.g., a treated edible oil, having a reduced concentration of (ii) as compared to the initial composition.

### BACKGROUND

Glycidyl esters are known carcinogens and mutagens found in processed edible oil. These heat-generated contaminants form at temperatures as low as 200° C.; however, much higher temperatures are required during the deodorization process to remove various volatile components from the oil. After crude oil is once refined, bleached, and deodorized (RBD), additional oil processing is required to lower the glycidyl ester concentrations to acceptable regulatory limits. These reduction methods include a wide variety of process combinations including, but not limited to, contacting the oil with an enzyme, shear mixing the oil with an acid, rebleaching the oil, and/or rerunning the deodorization at a lower temperature, but for an extended period of time. These known methods are not only inefficient and costly to operate, but further degrade the oil quality and reduce market price.

### SUMMARY

In one aspect, disclosed herein is a method comprising: contacting an initial composition comprising (i) a triglyceride and (ii) a glycidol, a glycidyl ester, or both glycidol and a glycidyl ester with an effective amount of silica-zirconia catalyst in a continuous reactor to form a treated composition: wherein: the silica-zirconia catalyst comprises porous silica particles impregnated with zirconia: and the concentration of (ii) in the treated composition is less than the concentration of (ii) in the initial composition.

In some embodiments, the continuous reactor is a packed bed reactor, a rotating bed reactor, a continuous stirred tank reactor (CSTR), a plug flow reactor, or a fluidized bed reactor. In some embodiments, the continuous reactor is a packed bed reactor.

In some embodiments, the silica-zirconia catalyst comprises particles having a median particle size of from about 0.1 μm to about 10,000 μm. In some embodiments, the silica-zirconia catalyst comprises particles having a median particle size of from about 50.0 μm to about 400 μm. In some embodiments, the silica-zirconia catalyst comprises particles having a median particle size of from about 80.0 μm to about 300 μm.

In some embodiments, the silica-zirconia catalyst comprises particles having a BET particle surface area of from about 50 m²/g up to about 800 m²/g. In some embodiments, the silica-zirconia catalyst comprises particles having a BET particle surface area of from about 150 m²/g up to about 450 m²/g.

In some embodiments, the silica-zirconia catalyst comprises particles having a pore volume of from about 0.1 cc/g to about 3.0 cc/g as determined by Barrett-Joyner-Halenda (BJH) method. In some embodiments, the silica-zirconia catalyst comprises particles having a pore volume of from about 0.5 cc/g to about 2.5 cc/g as determined by Barrett-Joyner-Halenda (BJH) method. In some embodiments, the silica-zirconia catalyst comprises particles having a pore volume of from about 0.8 cc/g to about 2.0 cc/g as determined by Barrett-Joyner-Halenda (BJH) method.

In some embodiments, the silica-zirconia catalyst exhibits a pH about 9 or less than 9. In some embodiments, the silica-zirconia catalyst exhibits a pH of from about 1 to about 8. In some embodiments, the silica-zirconia catalyst exhibits a pH of from about 2 to about 7. In some embodiments, the silica-zirconia catalyst exhibits a pH of from about 3 to about 6.

In some embodiments, the contacting step occurs at a temperature of from about 20° C. to about 250° C. In some embodiments, the contacting step occurs at a temperature of from about 30° C. to about 150° C. In some embodiments, the contacting step occurs at a temperature of from about 40° C. to about 120° C.

In some embodiments, the contacting step occurs at a gravimetric space velocity of about 1 hr⁻¹ to about 500 hr⁻¹. In some embodiments, the contacting step occurs at a gravimetric space velocity of about 1 hr⁻¹ to about 120 hr⁻¹.

In some embodiments, the contacting step comprises mixing the initial composition and the silica-zirconia catalyst in the continuous reactor. In some embodiments, the contacting step comprises mixing the initial composition and the silica-zirconia catalyst in the continuous reactor under inert gas flow or under vacuum. In some embodiments, the inert gas comprises nitrogen, argon, or a combination thereof.

In some embodiments, the initial composition further comprises an organic solvent. In some embodiments, the organic solvent comprises heptane, hexane, toluene, diethyl ether, an alcohol, or a combination thereof.

In some embodiments, the initial and treated composition comprises an edible oil. In some embodiments, the edible oil is soybean oil, palm oil, com oil, canola oil, rapeseed oil, fish oil, algal oil, sunflower oil, olive oil, vegetable oil, plant-derived oil, animal-derived oil, microbial-derived oil, or a combination thereof. In some embodiments, the edible oil is soy bean oil.

In some embodiments, the glycidyl ester is glycidyl oleate.

In some embodiments, the silica-zirconia catalyst is present in the continuous reactor at a weight percent relative to the amount of the treated composition of less than about 2%. In some embodiments, the silica-zirconia catalyst is present in the continuous reactor at a weight percent relative to the amount of the treated composition of less than about 0.5%. In some embodiments, the silica-zirconia catalyst is present in the continuous reactor at a weight percent relative to the amount of the treated composition of less than about 0.1%. In some embodiments, the silica-zirconia catalyst is present in the continuous reactor at a weight percent relative to the amount of the treated composition of less than about 0.05%. In some embodiments, the silica-zirconia catalyst is present in the continuous reactor at a weight percent relative to the amount of the treated composition of less than about 0.01%.

In some embodiments, the concentration of (ii) in the treated composition is less than 1.0 ppm. In some embodiments, the concentration of (ii) in the treated composition is less than 0.5 ppm. In some embodiments, the concentration of (ii) in the treated composition is less than 0.2 ppm. In some embodiments, the concentration of (ii) in the treated composition is less than 0.05 ppm.

In another aspect, disclosed herein is a method of treating an initial edible oil to produce a treated edible oil comprising the method of any one of the above embodiments, wherein the initial and treated compositions are the initial and treated edible oils, respectively.

In some embodiments, the initial edible oil is subjected to a refining, bleaching, and/or-deodorizing (RBD) treatment prior to contact with the silica-zirconia catalyst.

In some embodiments, the treated edible oil does not require processing after contact with the silica-zirconia catalyst.

In some embodiments, the initial edible oil has an initial free fatty acid content as measured as a content of oleic acid prior to contact with the silica-zirconia catalyst, and said method changes the initial free fatty acid content, as measured by AOCS Official Method Ca 5a-40, by less than about 20%. In some embodiments, the initial edible oil has an initial free fatty acid content as measured as a content of oleic acid prior to contact with the silica-zirconia catalyst, and said method changes the initial free fatty acid content, as measured by AOCS Official Method Ca 5a-40, by less than about 10%.

In some embodiments, the initial edible oil has an initial p-anisidine value (p-AV) prior to contact with the silica-zirconia catalyst, and said method changes the initial p-anisidine value (p-AV) by less than 10 units, as measured by AOCS Official Method Cd 18-90.

In some embodiments, the initial edible oil has an initial peroxide value (PV) prior to contact with the silica-zirconia catalyst, and said method changes the initial peroxide value by less than 10 units, as measured by AOCS Official Method Cd 8-53.

In some embodiments, the continuous reactor is a packed bed reactor or a CSTR.

### BRIEF DESCRIPTION OF THE DRAWINGS

FIG. 1 shows the comparison of the reaction rate constants (k) of packed bed and batch processes with RBD SBO, according to Example 1. Both processes used silica-zirconia catalyst to reduce glycidol-oleate in RBD SBO.

FIG. 2 shows catalytic rate constant of packed bed process with RBD palm oil, according to Example 2.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

Unless defined otherwise, all technical and scientific terms used herein generally have the same meaning as commonly understood by one of ordinary skill in the art to which this technology belongs.

It must be noted that as used herein and in the appended claims, the singular forms “a”, “and”, and “the” include plural referents unless the context clearly dictates otherwise. Thus, for example, reference to “an oxide” includes a plurality of such oxides and reference to “oxide” includes reference to one or more oxides and equivalents thereof known to those skilled in the art, and so forth.

As used herein, the term “about” modifies, for example, the quantity of an ingredient in a coated particle and/or composition, concentrations, volumes, process temperatures, process times, recoveries or yields, flow rates, and like values, and ranges thereof, employed in describing the embodiments of the disclosure, and refers to variation in the numerical quantity that may occur, for example, through typical measuring and handling procedures: through inadvertent error in these procedures; through differences in the ingredients used to carry out the methods; and like proximate considerations. The term “about” also encompasses amounts that differ due to aging of a formulation with a particular initial concentration or mixture, and amounts that differ due to mixing or processing a formulation with a particular initial concentration or mixture. If there are uses of the term which are not clear to persons of ordinary skill in the art, given the context in which it is used, “about” will mean up to plus or minus 10% of the particular term. Whether modified by the term “about”, the claims appended hereto include equivalents.

As used herein, a “batch reactor” refers to a closed system, where the reactor is filled with media and reactants. The reactants are allowed to react in the reactor for a fixed time. No feed is added or product withdrawn during this time. The reaction products are removed at the end of the reaction. The reactor may have an agitator and an internal heating or cooling system. In some cases, a batch reactor may be operated in semi-batch mode where one chemical is charged to the reactor and a second chemical is added slowly.

As used herein, the term “BET particle surface area” is defined as meaning a particle surface area as measured by the Brunauer Emmet Teller (BET) nitrogen adsorption method.

As used herein, a “continuous reactor” refers to a reactor that is characterized by a continuous flow of reactants into and a continuous flow of products from the reaction system (e.g., a packed bed reactor, a rotating bed reactor, a continuous stirred tank reactor (CSTR), a plug flow reactor, or a fluidized bed reactor).

As used herein, the term “gravimetric space velocity” refers to mass flow rate of a composition comprising reactants (grams/hour) per mass of the catalyst (grams) given by the following equation:

$$Gravimetric Space Velocity = \frac{{m}_{o}}{{m}_{c} * t} [ {hour}^{- 1} ]$$

where mₒ is the mass (g) of oil treated over a given time, t (hour), with a given mass of catalyst, m_{c} (g).

As used herein, the term “particle size” refers to median particle size (D50, which is a volume distribution with 50 volume percent of the particles are smaller than this number and 50 volume percent of the particles are bigger than this number in size) measured by dynamic light scattering when the particles are slurried in water or an organic solvent such as acetone or ethanol.

As used herein, the term “pore volume” refers to the median pore volume of a plurality of particles (e.g., the silica-zirconia particles disclosed herein) as determined using the Barrett-Joyner-Halenda (BJH) nitrogen porosimetry as described in DIN 66134, which is incorporated by reference herein in its entirety.

In one aspect, a method includes contacting an initial composition comprising (i) a triglyceride and (ii) glycidol, a glycidyl ester, or both glycidol and a glycidyl ester with an effective amount of silica-zirconia catalyst in a continuous reactor to form a treated composition, wherein the silica-zirconia catalyst comprises porous silica particles impregnated with zirconia: and wherein the concentration of (ii) in the treated composition is lower than a concentration of (ii) in the initial composition. The method according to the present disclosure is useful in reducing the concentration of glycidol, glycidyl ester, or both glycidol and glycidyl ester within the initial composition. The method reduces at least 50% of the concentration of glycidol, glycidyl ester, or both glycidol and glycidyl ester, within the initial composition, while utilizing a relatively low reaction time and temperature.

Unexpectedly, it has been found that utilizing a silica zirconia catalyst in a continuous reactor (e.g., a packed bed reactor) improves the reaction kinetics and slows down the catalyst deactivation of the silica zirconia catalyst, as compared to a silica zirconia catalyst in a batch reactor. In some embodiments, with other reaction parameters consistent with a batch process, utilizing a silica zirconia catalyst in a continuous reactor increases the reaction constant (k) of the silica zirconia catalyst by at least about 1% as compared to that in the batch process examples. This includes about 1%, 2%, 3%, 4%, 5%, 6%, 7%, 8%, 9%, 10%, 11%, or 12% increase in the reaction constant. In some embodiments, the increase is about 8% to about 12%. Consequently, the catalyst life of the silica zirconia catalyst is increased, and the overall silica zirconia dosage amount needed to reduce the same amount of total glycidol is reduced by utilizing a silica zirconia catalyst in a continuous reactor, as compared to a silica zirconia catalyst in a batch reactor.

Any continuous reactor known to one skilled in the arts may be used. Exemplary continuous reactors include but not limited to a packed bed reactor, a rotating bed reactor, a continuous stirred tank reactor (CSTR), a plug flow reactor, or a fluidized bed reactor.

In some embodiments, the continuous reactor may be a packed bed reactor. A packed bed reactor, also known as fixed bed reactor, may be a cylindrical tube filled with catalyst pellets (e.g., silica-zirconia catalysts) with reactants (e.g., an initial composition comprising (i) a triglyceride and (ii) glycidol, a glycidyl ester, or both glycidol and a glycidyl ester) undergoing conversion into products while flowing through the bed. The catalyst may be in one or more of multiple configurations such as but not limited to: one large bed, several horizontal beds, several parallel packed tubes, or multiple beds in their own shells. The various configurations may be adapted depending on the need to maintain temperature control within the system. The flow of the reactants in a fixed bed reactor may be downward under the force of gravity.

In some embodiments, the continuous reactor may be a rotating bed reactor. A rotating bed reactor holds a packed bed fixed within a basket with a central hole. When the basket is spinning immersed in a fluid phase, the inertia forces created by the spinning motion force the fluid outwards, thereby creating a circulating flow through the rotating packed bed. The rotating bed reactor shows relatively high rates of mass/heat transfer and good fluid mixing as compared to a packed bed reactor.

In some embodiments, the continuous reactor may be a continuous stirred tank reactor (CSTR). A CSTR is an open system, where material is free to enter or exit the system, which operates on a steady-state basis, where the conditions in the reactor do not change with time. Reactants are continuously introduced into the reactor, while products are continuously removed. CSTRs are well mixed, so the contents have relatively uniform properties such as temperature, density, etc. throughout. Also, conditions in the reactor's exit stream are the same as those inside the tank.

In some embodiments, the continuous reactor may be a fluidized bed reactor. In this type of reactor, a fluid (e.g., an initial liquid composition comprising (i) a triglyceride and (ii) glycidol, a glycidyl ester, or both glycidol and a glycidyl ester) is passed through a solid granular material (e.g., silica-zirconia catalysts) at high enough speeds to suspend the solid and cause it to behave as though it were a fluid. This process, known as fluidization, imparts many important advantages to a packed bed reactor. One key advantage of using a fluidized bed reactor is the ability to achieve a highly uniform temperature in the reactor.

The silica-zirconia catalyst of the present technology may be formed by a zirconia coating and/or impregnation step, followed by one or more additional steps such as a drying step, a calcining step, or both. See International Application Publication No. WO202026905, which is incorporated herein by reference in its entirety. The method of making silica-zirconia catalyst suitable for use in the herein-described methods comprises impregnating porous silica particles with zirconium acetate in acetic acid with water: drying the impregnated porous silica particles at about 105° C. for about 2 hours: and calcining the dried impregnated porous silica particles at about 500° C. for about 4 hours. Typically, the method of making silica-zirconia catalyst comprises an impregnating step that allows contact between the porous silica particles and the zirconium acetate for a desired period of time, e.g., 30 minutes or any desired period of time. After the impregnating step and before the drying step, the method of making silica-zirconia catalyst comprises allowing the impregnated porous silica particles to mill for about 60 minutes. It should be understood that the impregnated porous silica particles may mill (or be milled) for any desired period of time. The zirconia may be impregnated onto at least a portion of the surface of the porous silica particles, and/or at least a portion of the pores of the porous silica particles.

Suitable porous silica particles useful in the preparation of the silica-zirconia catalysts of the present disclosure include, but are not limited to, silica gel, precipitated silica, fumed silica and colloidal silica. Suitable porous silica also includes, but is not limited to, ordered mesoporous silica prepared through an organic template (e.g., a surfactant) during the formation of silica particles, followed by a high temperature treatment to “burn off” the organics. Particularly preferred porous silica particles comprise silica gel or precipitated silica particles. Any commercially available porous silica particles may be used to form the silica-zirconia catalysts of the present disclosure. Commercially available porous silica particles useful for forming the silica-zirconia catalysts of the present disclosure include, but are not limited to, particles available from W. R. Grace (Columbia, MD) under the trade designation SYLOID® such as SYLOID® C807 silica gel particles and SYLOID® MX106 precipitated silica particles, SYLOBLOC® silica particles, and DARACLAR® silica particles. The porous silica particles used to form the silica-zirconia catalysts of the present disclosure comprise porous silica having a purity of at least about 93.0%, at least about 93.5%, at least about 94.0%, at least about 95.0%, at least about 96.0%, at least about 97.0%, at least about 98.0%, or up to 100% by weight SiO2based upon the total weight of the porous silica particle. The porous silica particles used to form the silica-zirconia catalysts of the present disclosure may have a variety of different symmetrical, asymmetrical or irregular shapes, including chain, rod or lath shape. The porous silica particles may have different structures including amorphous or crystalline, etc. The porous silica particles may include mixtures of particles comprising different compositions, sizes, shapes or physical structures, or that may be the same except for different surface treatments. Porosity of the porous silica particles may be intraparticle or interparticle in cases where smaller particles are agglomerated to form larger particles.

In some embodiments, the silica-zirconia catalyst of the present technology comprise at least about 0.01 weight percent (wt. %) of zirconia based on a total weight of the silica-zirconia catalyst. In some embodiments, the silica-zirconia catalyst of the present technology comprise from about 0.01 wt. % to about 1.0 wt. %, about 1.0 wt. % to about 5.0 wt. %, from about 5.0 wt. % to about 10.0 wt. %, from about 10.0 wt. % to about 15.0 wt. %, from about 15.0 wt. % to about 20.0 wt. %, from about 20.0 wt. % to about 25.0 wt. %, from about 25.0 wt. % to about 30.0 wt. %, from about 30.0 wt. % to about 35.0 wt. %, from about 35.0 wt. % to about 40.0 wt. %, from about 40.0 wt. % to about 45.0 wt. %, or from 45.0 wt. % to about 50.0 wt. % of zirconia based on a total weight of the silica-zirconia catalyst. In some embodiments, the silica-zirconia catalyst of the present technology comprise from about 1.5 wt. % to about 14.3 wt. % of zirconia based on a total weight of the silica-zirconia catalyst. In some embodiments, the silica-zirconia catalyst of the present technology comprise from about 2.4 wt. % to about 5.0 wt. % of zirconia based on a total weight of the silica-zirconia catalyst. It should be understood that the silica-zirconia catalyst of the present technology may comprise any amount of zirconia ranging from about 0.01 wt. % to about 50.0 wt. % (or greater) (or any range of amounts of zirconia between about 0.01 wt. % and about 50.0 wt. %, in increments of 0.01 wt. %, e.g., from about 0.02 wt. % to about 49.99 wt. %, based on a total weight of the silica-zirconia catalyst).

In some embodiments, the silica-zirconia catalyst has a median particle size of from about 0.1 μm to about 10,000 μm (or any range of median particle size between about 0.1 μm and about 10,000 μm, in increments of 0.1 μm, e.g., from about 0.2 μm to about 9,999.9 μm). In some embodiments, the silica-zirconia catalyst of the present technology has a median particle size of from about 50 μm to about 75 μm, from about 75 μm to about 100 μm, from about 100 μm to about 125 μm, from about 125 μm to about 150 μm, from about 150 μm to about 175 μm, from about 175 μm to about 200 μm, from about 200 μm to about 225 μm, from about 225 μm to about 250 μm, from about 250 μm to about 275 μm, from about 275 μm to about 300 μm, from about 300 μm to about 325 μm, from about 325 μm to about 350 μm, from about 350 μm to about 375 μm, or from about 375 μm to about 400 μm. In some embodiments, the silica-zirconia catalyst of the present technology has a median particle size of from about 80 μm to about 300 μm.

In some embodiments, the silica-zirconia catalyst of the present technology may have a BET particle surface area of at least about 10 m²/g, at least about 25.0 m²/g, up to about 2000 m²/g, or greater. In some embodiments, the silica-zirconia catalyst have a BET particle surface area of about 50 m²/g to about 100 m²/g, about 100 m²/g to about 150 m²/g, about 150 m²/g to about 200 m²/g, about 200 m²/g to about 250 m²/g, about 250 m²/g to about 300 m²/g, about 300 m²/g to about 350 m²/g, about 350 m²/g to about 400 m²/g, about 400 m²/g to about 450 m²/g, about 450 m²/g to about 500 m²/g, about 500 m²/g to about 550 m²/g, about 550 m²/g to about 600 m²/g, about 600 m²/g to about 650 m²/g, about 650 m²/g to about 700 m²/g, about 700 m²/g to about 750 m²/g, or about 750 m²/g to about 800 m²/g. However, it should be understood that the silica-zirconia catalyst of the present technology can have any BET particle surface area ranging from about 10 m²/g to about 2000 m²/g, or greater (or any range of BET particle surface area values between about 10 m²/g and about 2000 m²/g, in increments of 0.1 m²/g, e.g., from about 10.1 m²/g to about 1999.9 m²/g).

In some embodiments, the silica-zirconia catalyst of the present technology may have a pore volume of at least 0.01 cubic centimeters/gram (cc/g) as determined by Barrett-Joyner-Halenda (BJH) method. In some embodiments, the silica-zirconia catalyst have a pore volume of from about 0.01 cc/g to about 0.1 cc/g, from about 0.1 cc/g to about 0.2 cc/g, from about 0.2 cc/g to about 0.3 cc/g, from about 0.3 cc/g to about 0.4 cc/g, from about 0.4 cc/g to about 0.5 cc/g, from about 0.5 cc/g to about 0.6 cc/g, from about 0.6 cc/g to about 0.7 cc/g, from about 0.7 cc/g to about 0.8 cc/g, from about 0.8 cc/g to about 0.9 cc/g, from about 0.9 cc/g to about 1.0 cc/g, from about 1.0 cc/g to about 1.1 cc/g, from about 1.1 cc/g to about 1.2 cc/g, from about 1.2 cc/g to about 1.3 cc/g, from about 1.3 cc/g to about 1.4 cc/g, from about 1.4 cc/g to about 1.5 cc/g, from about 1.5 cc/g to about 1.6 cc/g, from about 1.6 cc/g to about 1.7 cc/g, from about 1.7 cc/g to about 1.8 cc/g, from about 1.8 cc/g to about 1.9 cc/g, from about 1.9 cc/g to about 2.0 cc/g, from about 2.0 cc/g to about 2.1 cc/g, from about 2.1 cc/g to about 2.2 cc/g, from about 2.2 cc/g to about 2.3 cc/g, from about 2.3 cc/g to about 2.4 cc/g, from about 2.4 cc/g to about 2.5 cc/g, from about 2.5 cc/g to about 2.6 cc/g, from about 2.6 cc/g to about 2.7 cc/g, from about 2.7 cc/g to about 2.8 cc/g, from about 2.8 cc/g to about 2.9 cc/g, or from about 2.9 cc/g to about 3.0 cc/g as determined by Barrett-Joyner-Halenda (BJH) method. In some embodiments, the silica-zirconia catalyst have a pore volume of from about 0.1 cc/g to about 2.5 cc/g, from about 0.5 cc/g to about 2.5 cc/g, or from about 0.8 cc/g to about 2.0 cc/g as determined by Barrett-Joyner-Halenda (BJH) method. However, it should be understood that the silica-zirconia catalyst of the present technology may have a pore volume of from about 0.01 cc/g to about 3.00cc/g (or greater) as determined by Barrett-Joyner-Halenda (BJH) method (or any range of pore volume between about 0.01 cc/g and about 3.0 cc/g, in increments of 0.01 cc/g, e.g., from about 0.02 cc/g to about 2.99 cc/g).

In some embodiments, the silica-zirconia catalyst exhibits a pH of about 9, less than 9, less than 8, less than 7, less than 6, less than 5, less than 4, less than 3, less than 2, or less than 1. In some embodiments, the silica-zirconia catalyst exhibits a pH of about 1 to about 8. In some embodiments, the silica-zirconia catalyst exhibits a pH of about 2 to about 7. In some embodiments, the silica-zirconia catalyst exhibits a pH of about 3 to about 6.

In some embodiments, the disclosed method comprises contacting an initial composition comprising (i) a triglyceride and (ii) glycidol, a glycidyl ester, or both glycidol and a glycidyl ester with an effective amount of silica-zirconia catalyst in a continuous reactor at room temperature, e.g., about 20-25° C., up to about 250° C. In some embodiments, the contacting step occurs at a temperature of from about 20° C. to about 30° C., from about 30° C. to about 40° C., from about 40° C. to about 50° C., from about 50° C. to about 60° C., from about 60° C. to about 70° C., from about 70° C. to about 80° C., from about 80° C. to about 90° C., from about 90° C. to about 100° C., from about 100° C. to about 110° C., from about 110° C. to about 120° C., from about 120° C. to about 130° C., from about 130° C. to about 140° C., from about 140° C. to about 150° C., from 150° C. to about 160° C., from about 160° C. to about 170° C., from about 170° C. to about 180° C., from about 180° C. to about 190° C., from about 190° C. to about 200° C., from about 200° C. to about 210° C., from about 210° C. to about 220° C., from about 220° C. to about 230° C., from about 230° C. to about 240° C., or from about 240° C. to about 250° C. In some embodiments, the contacting step occurs at a temperature of about 90.0° C.

In some embodiments, the contacting step occurs at a gravimetric space velocity of about 0.1 hr⁻¹ to about 500 hr⁻¹. In some embodiments, the contacting step occurs at a gravimetric space velocity of about 0.1 hr⁻¹to about 5 hr⁻¹, about 5 hr⁻¹ to about 10 hr⁻¹, about 10hr⁻¹ to about 20 hr⁻¹, about 20 hr⁻¹ to about 30 hr⁻¹, about 30 hr⁻¹ to about 40 hr⁻¹, about 40 hr⁻¹ to about 50 hr⁻¹, about 50 hr⁻¹ to about 60 hr⁻¹, about 60 hr⁻¹ to about 70 hr⁻¹, about 70 hr⁻¹ to about 80 hr⁻¹, about 80 hr⁻¹ to about 90 hr⁻¹, about 90 hr⁻¹ to about 100 hr⁻¹, about 100 hr⁻¹ to about 110 hr⁻¹, about 110 hr⁻¹ to about 120 hr⁻¹, about 120 hr⁻¹ to about 180 hr⁻¹, about 180 hr⁻¹ to about 240 hr⁻¹, about 240 hr⁻¹ to about 300 hr⁻¹, about 300 hr⁻¹ to about 360 hr⁻¹, about 360 hr⁻¹ to about 420 hr⁻¹, or about 420 hr⁻¹ to about 500 hr⁻¹.

In some embodiments, the disclosed method comprises contacting an initial composition comprising (i) a triglyceride and (ii) glycidol, a glycidyl ester, or both glycidol and a glycidyl ester with an effective amount of silica-zirconia catalyst in a continuous reactor under inert gas flow or under vacuum to minimize the oxygen concentration in the atmosphere.

In some embodiments, the contacting step occurs under vacuum, wherein the pressure in the continuous reactor is from about 0.05 bar to about 0.1 bar, from about 0.10 bar to about 0.20 bar, from about 0.20 bar to about 0.30 bar, from about 0.30 bar to about 0.40 bar, from about 0.40 bar to about 0.50 bar, from about 0.50 bar to about 0.60 bar, from about 0.60 bar to about 0.70 bar, from about 0.70 bar to about 0.80 bar, from about 0.80 bar to about 0.90 bar, or from about 0.90 bar to about 0.95 bar.

In some embodiments, the contacting step occurs under inert gas flow, wherein the inert gas comprises nitrogen, argon, or a combination thereof.

In some embodiments, the initial composition further comprises an organic solvent. In some embodiments, the organic solvent comprises heptane, hexane, toluene, diethyl ether, an alcohol, or a combination thereof.

In some embodiments, the initial and treated compositions comprise an edible oil. Suitable edible oils include, but are not limited to, soy bean oil, palm oil, corn oil, canola oil, rapeseed oil, fish oil, algal oil, sunflower oil, olive oil, vegetable oil, plant-derived oil, animal-derived oil, microbial-derived oil, or any combination thereof. In some embodiments, the edible oil is soybean oil.

In some embodiments, the glycidyl ester is glycidyl oleate.

In some embodiments, the silica-zirconia catalyst is present in the continuous reactor at a weight percent relative to the amount of the treated composition of less than about 2%. In some embodiments, the silica-zirconia catalyst is present in the continuous reactor at a weight percent relative to the amount of the treated composition of less than about 1%, less than about 0.5%, less than about 0.1%, less than about 0.05%, or less than about 0.01%.

In some embodiments, the concentration of glycidol, a glycidyl ester, or both glycidol and a glycidyl ester, in the treated composition is less than about 1.0 ppm, less than about 0.9 ppm, less than about 0.8 ppm, less than about 0.7 ppm, less than about 0.6 ppm, less than about 0.5 ppm, less than about 0.4 ppm, less than about 0.3 ppm, less than about 0.2 ppm, less than about 0.1 ppm, or less than about 0.05 ppm.

In another aspect, the present disclosure provides a method of treating an initial edible oil to produce a treated edible oil comprising the method of any one of the above embodiments, wherein the initial and treated compositions are the initial and treated edible oils, respectively.

In some embodiments, the edible oil is subjected to a refining, bleaching and/or-deodorizing (RBD) treatment prior to contact with the silica-zirconia catalyst.

In some embodiments, the treated edible oil does not require processing after contact with the silica-zirconia catalyst (i.e., do not require further processing including, but not limited to, contacting the oil with an enzyme, shear mixing the oil with an acid, rebleaching the oil, and/or rerunning the deodorization at a lower temperature but for an extended period of time, or any combination of the process steps mentioned).

In some embodiments, the disclosed method of treating a given initial edible oil is capable of reducing the concentration of glycidol, glycidyl ester, or both glycidol and glycidyl ester within the edible oil to an extremely low level with little impact on (i) a free fatty acid content of the edible oil, e.g., oleic acid content, as measured by AOCS Official Method Ca 5a-40, and/or (ii) an oxidation level of the edible oil as measured by (a) the p-anisidine value of the edible oil as measured, for example, by AOCS Official Method Cd 18-90, (b) the peroxide value of the edible oil as measured, for example, by AOCS Official Method Cd 8-53, or (c) both (a) and (b). AOCS Official Method Ca 5a-40, 18-90, and 8-53 are incorporated by reference herein in their entireties. The methods described in AOCS Official Method Ca 5a-40, 18-90, and 8-53 are also well known to a skilled person in the art.

In some embodiments, the method has a negligible change on the free fatty acid content (e.g., oleic acid) of the edible oil, as measured by AOCS Official Method Ca 5a-40. In some embodiments, the initial edible oil has an initial free fatty acid content as measured as a content of oleic acid prior to contact with the silica-zirconia catalyst, and said method changes the initial free fatty acid content, as measured by AOCS Official Method Ca 5a-40, by less than about 20%, by less than about 19%, by less than about 18%, by less than about 17%, by less than about 16%, by less than about 15%, by less than about 14%, by less than about 13%, by less than about 12%, by less than about 11%, by less than about 10%, by less than about 9%, by less than about 8%, by less than about 7%, by less than about 6%, by less than about 5%, by less than about 4%, by less than about 3%, by less than about 2%, or by less than about 1%.

In some embodiments, the initial edible oil has an initial p-anisidine value (p-AV) prior to contact with the silica-zirconia catalyst, and said method changes the initial p-anisidine value (p-AV) by less than 10 units, less than 9 units, less than 8 units, less than 7 units, less than 6 units, less than 5 units, less than 4 units, less than 3 units, less than 2 units, or less than 1 unit, as measured by AOCS Official Method Cd 18-90.

In some embodiments, the initial edible oil has an initial peroxide value (PV) prior to contact with the silica-zirconia catalyst, and said method changes the initial peroxide value by less than 10 units, less than 9 units, less than 8 units, less than 7 units, less than 6 units, less than 5 units, less than 4 units, less than 3 units, less than 2 units, or less than 1 unit, as measured by AOCS Official Method Cd 8-53.

In some embodiments, the continuous reactor may be a packed bed reactor or a CSTR.

The present disclosure is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present disclosure and/or the scope of the appended claims.

### EXAMPLES

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

### Catalyst Evaluations, Methods and Materials

### Nitrogen Pore Volume and BET Surface Area Measurements of Silica-Zirconia Particle Samples

The silica-zirconia materials of the present disclosure are typical mesoporous materials (pore size 2-50 nm, IUPAC definition), typically displaying type IV isotherms (IUPAC classification). Thus, nitrogen porosimetry is an appropriate method for their characterization, and the determination of surface area using the BET method and pore volume using the BJH method from nitrogen adsorption and desorption isotherms are well established and appropriate methods and are used herein. Nitrogen pore volumes of silica-zirconia catalysts were measured using a TriStar Analyzer, Model 3000 and Model II Plus, Micromeritics Instrument Corporation, One Micromeritics Drive, Norcross, Georgia. The samples were activated in flowing air or nitrogen at 400° C. temperature for 2 hours prior to analysis. Surface areas were calculated from multi-point values of the nitrogen volumetric uptake during the adsorption branch at low P/Pₒ=˜0.3 to 0.4 partial pressures. The adsorption branch of the isotherm was stopped at a partial pressure of P/Pₒ=0.967 and then the descending branch of the isotherm was measured. The pore volumes were calculated from the desorption branch using the BJH method.

### Total Glycidol Concentration Analysis

The total glycidol concentration of a given sample was determined using AOCS Official Method Cd 29c-13, the subject matter of which is hereby incorporated by reference in its entirety. This method determines a concentration of the sum of (i) the total free glycidol and (ii) bound glycidol (i.e., glycidyl esters) present in a given sample.

### Reaction Rate Constant Kinetics Analysis

The reaction rate constant for the batch and continuous flow reactor were calculated by the following equation:

$$k ( 1 st order reaction rate constant ) = \frac{{m}_{o}}{{m}_{c} * t} ln ( \frac{{C}_{0}}{{C}_{f}} ) [ {min}^{- 1} ]$$

where mₒ is the mass (g) of oil treated over a given time, t (min), with a given mass of catalyst, m_{c} (g). Cₒ (ppm) is the concentration of total glycidol in the initial oil, and C_{f} (ppm) is the concentration of total glycidol in the treated oil.

### Catalyst Synthesis

The porous silica-zirconia catalyst particles were prepared using the following procedure. A desired amount of zirconium acetate was diluted in acetic acid with water, and used to impregnate the porous silica particles over the course of 30 minutes, and subsequently allowed to mill for an additional hour. The material was then dried at 105° C. for 2 hours, and then calcined at 500° C. for 4 hours.

The resulting silica-zirconia catalyst had a zirconia concentration ranging from 0.01 wt. % to 49.99 wt. %. As discussed further below, in some embodiments, silica-zirconia catalyst having a zirconia concentration ranging from about 2.00 wt. % to about 20.00 wt. % provided effective results. Final zirconia concentrations were determined using ICP elemental trace analysis.

Twelve silica-zirconia catalyst samples were used to evaluate the reaction kinetics and determine the first order reaction rate constant. Properties of catalysts A through L are shown in Table 1 below. To determine the reaction rate constant associated with each catalyst, 100 g of soybean oil spiked with glycidyl-oleate was added to a round bottom flask equipped with argon flow to displace any oxygen present. Mixing was set to 250 rpm and the oil temperature was increased to 90° C. Once the oil temperature reached 90° C., 2 grams of the catalyst were added to the reactor. After 15 min, agitation and temperature control were shut off and the catalyst was filtered out. Total glycidol was measured in the initial oil and the final oil. This procedure was repeated for each type of catalyst listed below (Table 1).

TABLE 1
Silica-zirconia catalysts used in the present study

| | ZrO₂ | Surface | Pore Volume | | Particle Size | Reaction |
|---|---|---|---|---|---|---|
| Catalyst | (%) | Area (m²/g) | (cc/g) | pH | (μm) | Constant (min⁻¹) |
| A | 0.01 | 330 | 1.6 | 3.6 | 88-210 | 0.8 |
| B | 2.5 | 339 | 1.6 | 4.1 | 88-210 | 5.7 |
| C | 5.1 | 326 | 1.6 | 4.2 | 88-210 | 12.5 |
| D | 10.7 | 305 | 1.5 | 4.3 | 88-210 | 28.6 |
| E | 11.0 | 305 | 1.5 | 4.3 | 88-210 | 32.0 |
| F | 20.7 | 294 | 1.2 | 5.0 | 88-210 | 31.9 |
| G | 6.0 | 77 | 0.5 | 7.7 | 80-200 | 7.1 |
| H | 10.8 | 284 | 1.5 | 5.6 | 80-200 | 20.0 |
| I | 10.3 | 320 | 1.1 | 6.1 | 150 | 7.5 |
| J | 9.0 | 312 | 1.3 | 4.6 | >420 | 5.0 |
| K | 9.2 | 313 | 1.5 | 4.8 | 210-420 | 9.8 |
| L | 4.4 | 357 | 1.3 | 3.8 | 10-1000 | 21.3 |

### Example 1—Packed Bed Process with RBD Soybean Oil Spiked with Glycidol-Oleate

The catalyst with the highest activity (catalyst E in Table 1) was selected to test in a packed bed process to compare to the batch process with recycled catalyst.

### Batch Process of RBD Soybean Oil Spiked with Glycidol-Oleate with Recycled Catalyst

2 kg of RBD soybean oil (SBO) was spiked with glycidol-oleate. Spiked SBO (100 g) of was charged to a round bottom flask equipped with argon flow to displace any oxygen present. Mixing was set to 250 rpm and the oil temperature was increased to 90° C. Once the oil temperature reached 90° C., 2 grams of catalyst E were added to the reactor. After 15 min, agitation and temperature control were shut off and the catalyst was filtered out. The glycidol-oleate level in the processed oil was analyzed. The procedure was repeated 19 more times with the recovered 2 grams of catalyst E from the previous step and 87 g of fresh spiked SBO.

### Packed Bed Process with RBD Soybean Oil Spiked with Glycidol-Oleate

A packed bed reactor was packed with glass wool provided by Thermo Scientific (catalog number: 386062500), inert zirconia beads from Bio Spec Products (catalog number: NC0362415), and 2 grams of catalyst E. The catalyst bed was heated to 90° C. then RBD SBO flow through the apparatus was started at 6.7 g/min to match the conditions for the batch process described above (100 g oil and 2 g of catalyst for 15 min contact time).

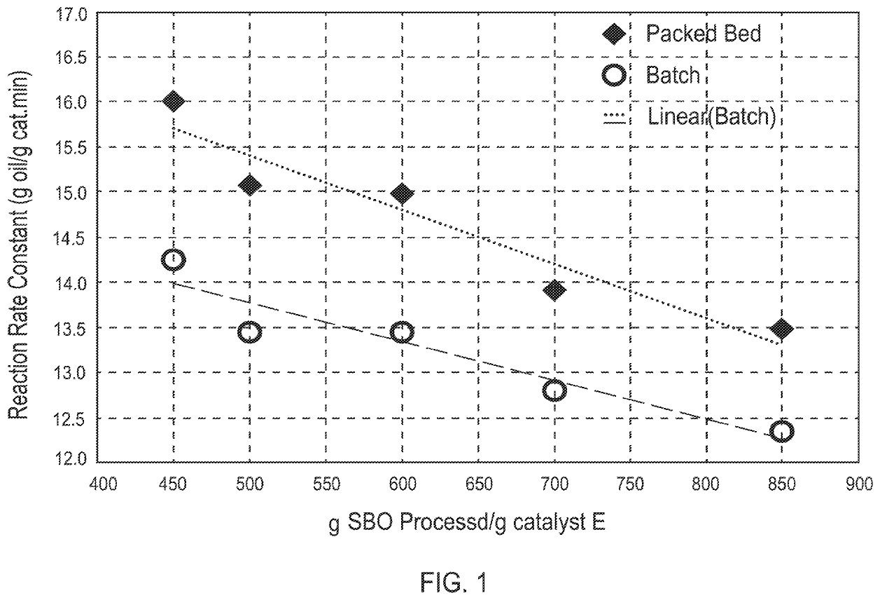

The first order reaction rate constant for both processes are summarized and compared in FIG. 1 and Table 2. The data shows that, when processing the same amount of spiked SBO with the same amount of catalyst E, the first order reaction rate constant is higher by more than 8% to more than 12% in the packed bed reactor compared to the batch process with recycled catalyst. This difference is statistically significant as indicated in Table 3 by a P =0.00046, well below 0.05, in a t-test for paired two samples for a 95% confidence interval. This data also suggests that the catalyst deactivation is slower in the packed bed process, meaning the packed bed process yields lower total glycidol concentrations after processing the same amount of oil and thus the catalyst's activity life is extended. The overall silica zirconia dosage requirements are therefore lower in the packed bed process compared to that in the recycled batch process.

TABLE 2
Rate constant for Packed Bed vs. Batch Processes

| | Packed Bed | Batch | |
|---|---|---|---|
| SBO Processed | Rate Constant | Rate Constant | |
| g oil/g Catalyst E | Min⁻¹ | Min⁻¹ | % Difference |
| 450 | 16.00 | 14.25 | 12.26 |
| 500 | 15.07 | 13.45 | 12.10 |
| 600 | 14.97 | 13.45 | 11.35 |
| 700 | 13.91 | 12.83 | 8.45 |
| 850 | 13.48 | 12.36 | 9.07 |

TABLE 3
t-Test for Paired Two Sample for Means

| | Packed Bed | Batch |
|---|---|---|
| Mean | 14.68811 | 13.26700 |
| Variance | 1.00152 | 0.51183 |
| Observations | 5.00000 | 5 |
| Pearson Correlation | 0.99329 | |
| Hypothesized Mean Difference | 0.00000 | |
| df | 4.00000 | |
| t Stat | 10.53249 | |
| P(T <= t) one-tail | 0.00023 | |
| t Critical one-tail | 2.13185 | |
| P(T <= t) two-tail | 0.00046 | |
| t Critical two-tail | 2.77645 | |

### Example 2-Packed Bed Process with RBD Palm Oil

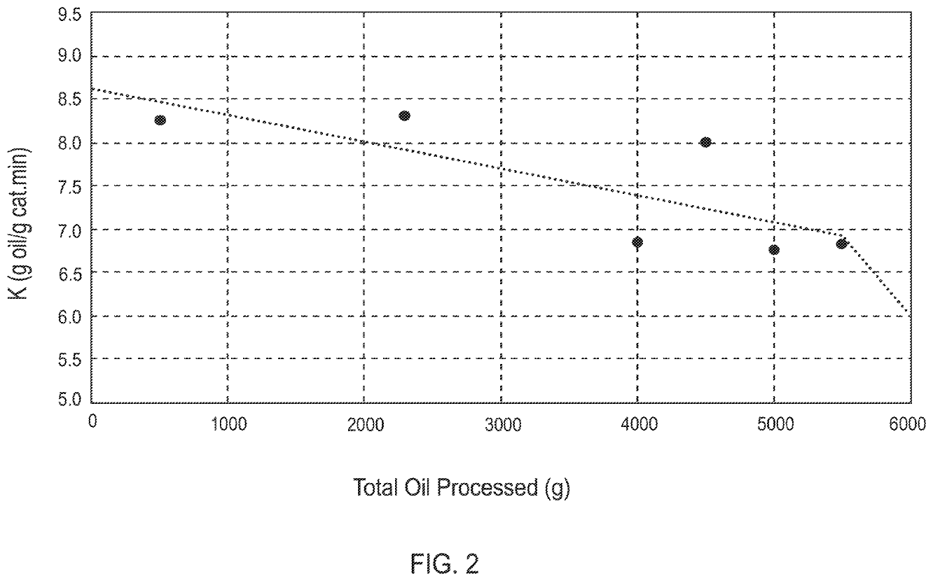

A packed bed reactor was packed with glass wool provided by Thermo Scientific (catalog number: 386062500), inert zirconia beads from Bio Spec Products (catalog number: NC0362415), and 2 grams of catalyst E. The catalyst bed was heated to 90° C. then flow of RBD palm oil, with a total glycidol content of 3.34 ppm, was started at 3.4 g/min through the apparatus, corresponding to a gravimetric space velocity of 102 hr⁻¹. The reaction was continued until 5,500 g of palm oil were processed over the catalyst. The overall catalyst dosage was 0.036% by weight (g of catalyst/100 g of oil) and, although the catalyst deactivated over the length of the test run, the final catalyst activity (FIG. 2) was still sufficient to reduce the glycidol levels in the oil to below 0.061 ppm.

The performance of the catalyst was then tested at various space velocities by changing the flow rate of palm oil through the packed bed, all other conditions being maintained the same. 100 g of RBD palm oil were reacted under each set of conditions. The results, summarized in Table 4, show that glycidol levels in the processed palm oil remain below 1 ppm for space velocities as high as 420 hr⁻¹.

TABLE 4
Packed Bed Reactor Performance vs Gravimetric Space Velocity

| | | Gravi- | | | |
|---|---|---|---|---|---|
| | Palm Oil | metric | GE in | Rate | Catalyst |
| Test | Flow | Space | Processed | Constant | Dosage* |
| # | rate | Velocity | oil | g/(g cat. | g cat/ |
| Units | g/min | hr⁻¹ | PPM | min) | 100 g Oil |
| 1 | 3.4 | 102 | 0.061 | 6.83 | 1.6 10⁻⁶ |
| 2 | 1.7 | 51 | 0.017 | 4.47 | 4.5 10⁻⁸ |
| 3 | 7.0 | 210 | 0.347 | 7.95 | 0.003 |
| 4 | 14.0 | 420 | 0.908 | 9.18 | 5.5 |

### Certain Embodiments

Embodiment 1. A method comprising:
contacting an initial composition comprising (i) a triglyceride and (ii) a glycidol, a glycidyl ester, or both glycidol and a glycidyl ester with an effective amount of silica-zirconia catalyst in a continuous reactor to form a treated composition:
wherein:
   the silica-zirconia catalyst comprises porous silica particles impregnated with zirconia: and
   the concentration of (ii) in the treated composition is less than the concentration of (ii) in the initial composition.

Embodiment 2. The method of Embodiment 1, wherein the continuous reactor is a packed bed reactor, a rotating bed reactor, a continuous stirred tank reactor (CSTR), a plug flow reactor, or a fluidized bed reactor.

Embodiment 3. The method of Embodiment 1 or Embodiment 2, wherein the continuous reactor is a packed bed reactor.

Embodiment 4. The method of any one of Embodiments 1-3, wherein the silica-zirconia catalyst comprises particles having a median particle size of from about 0.1 μm to about 10,000 μm.

Embodiment 5. The method of any one of Embodiments 1-4, wherein the silica-zirconia catalyst comprises particles having a median particle size of from about 50.0 μm to about 400 μm.

Embodiment 6. The method of any one of Embodiments 1-5, wherein the silica-zirconia catalyst comprises particles having a median particle size of from about 80.0 μm to about 300 μm.

Embodiment 7. The method of any one of Embodiments 1-6, wherein the silica-zirconia catalyst comprises particles having a BET particle surface area of from about 50 m²/g up to about 800 m²/g.

Embodiment 8. The method of any one of Embodiments 1-7, wherein the silica-zirconia catalyst comprises particles having a BET particle surface area of from about 150 m²/g up to about 450 m²/g.

Embodiment 9. The method of any one of Embodiments 1-8, wherein the silica-zirconia catalyst comprises particles having a pore volume of from about 0.1 cc/g to about 3.0 cc/g as determined by Barrett-Joyner-Halenda (BJH) method.

Embodiment 10. The method of any one of Embodiments 1-9, wherein the silica-zirconia catalyst comprises particles having a pore volume of from about 0.5 cc/g to about 2.5 cc/g as determined by Barrett-Joyner-Halenda (BJH) method.

Embodiment 11. The method of any one of Embodiments 1-10, wherein the silica-zirconia catalyst comprises particles having a pore volume of from about 0.8 cc/g to about 2.0 cc/g as determined by Barrett-Joyner-Halenda (BJH) method.

Embodiment 12. The method of any one of Embodiments 1-11, wherein the silica-zirconia catalyst exhibits a pH about 9 or less than 9.

Embodiment 13. The method of any one of Embodiments 1-12, wherein the silica-zirconia catalyst exhibits a pH of from about 1 to about 8.

Embodiment 14. The method of any one of Embodiments 1-13, wherein the silica-zirconia catalyst exhibits a pH of from about 2 to about 7.

Embodiment 15. The method of any one of Embodiments 1-14, wherein the silica-zirconia catalyst exhibits a pH of from about 3 to about 6.

Embodiment 16. The method of any one of Embodiments 1-15, wherein the contacting step occurs at a temperature of from about 20° C. to about 250° C.

Embodiment 17. The method of any one of Embodiments 1-16, wherein the contacting step occurs at a temperature of from about 30° C. to about 150° C.

Embodiment 18. The method of any one of Embodiments 1-17, wherein the contacting step occurs at a temperature of from about 40° C. to about 120° C.

Embodiment 19. The method of any one of Embodiments 1-18, wherein the contacting step occurs at a gravimetric space velocity of about 1 hr⁻¹ to about 500 hr⁻¹.

Embodiment 20. The method of any one of Embodiments 1-19, wherein the contacting step occurs at a gravimetric space velocity of about 1 hr⁻¹ to about 120 hr⁻¹.

Embodiment 21. The method of any one of Embodiments 1-20, wherein the contacting step comprises mixing the initial composition and the silica-zirconia catalyst in the continuous reactor.

Embodiment 22. The method of any one of Embodiments 1-21, wherein the contacting step comprises mixing the initial composition and the silica-zirconia catalyst in the continuous reactor under inert gas flow or under vacuum.

Embodiment 23. The method of Embodiment 22, wherein the inert gas comprises nitrogen, argon, or a combination thereof.

Embodiment 24. The method of any one of Embodiments 1-23, wherein the initial composition further comprises an organic solvent.

Embodiment 25. The method of Embodiment 24, wherein the organic solvent comprises heptane, hexane, toluene, diethyl ether, an alcohol, or a combination thereof.

Embodiment 26. The method of any one of Embodiments 1-25, wherein the initial and treated composition comprises an edible oil.

Embodiment 27. The method of Embodiment 26, wherein the edible oil is soybean oil, palm oil, com oil, canola oil, rapeseed oil, fish oil, algal oil, sunflower oil, olive oil, vegetable oil, plant-derived oil, animal-derived oil, microbial-derived oil, or a combination thereof.

Embodiment 28. The method of any one of Embodiments 26-27, wherein the edible oil is soy bean oil.

Embodiment 29. The method of any one of Embodiments 1-28, wherein the glycidyl ester is glycidyl oleate.

Embodiment 30. The method of any one of Embodiments 1-29, wherein the silica-zirconia catalyst is present in the continuous reactor at a weight percent relative to the amount of the treated composition of less than about 2%.

Embodiment 31. The method of any one of Embodiments 1-30, wherein the silica-zirconia catalyst is present in the continuous reactor at a weight percent relative to the amount of the treated composition of less than about 0.5%.

Embodiment 32. The method of any one of Embodiments 1-31, wherein the silica-zirconia catalyst is present in the continuous reactor at a weight percent relative to the amount of the treated composition of less than about 0.1%.

Embodiment 33. The method of any one of Embodiments 1-32, wherein the silica-zirconia catalyst is present in the continuous reactor at a weight percent relative to the amount of the treated composition of less than about 0.05%.

Embodiment 34. The method of any one of Embodiments 1-33, wherein the silica-zirconia catalyst is present in the continuous reactor at a weight percent relative to the amount of the treated composition of less than about 0.01%.

Embodiment 35. The method of any one of Embodiments 1-34 wherein the concentration of (ii) in the treated composition is less than 1.0 ppm.

Embodiment 36. The method of any one of Embodiments 1-35, wherein the concentration of (ii) in the treated composition is less than 0.5 ppm.

Embodiment 37. The method of any one of Embodiments 1-36, wherein the concentration of (ii) in the treated composition is less than 0.2 ppm.

Embodiment 38. The method of any one of Embodiments 1-37, wherein the concentration of (ii) in the treated composition is less than 0.05 ppm.

Embodiment 39. A method of treating an initial edible oil to produce a treated edible oil comprising the method of any one of Embodiments 1-38, wherein the initial and treated compositions are the initial and treated edible oils, respectively.

Embodiment 40. The method of Embodiment 39, wherein the initial edible oil is subjected to a refining, bleaching, and/or-deodorizing (RBD) treatment prior to contact with the silica-zirconia catalyst.

Embodiment 41. The method of Embodiment 39 or Embodiment 40, wherein the treated edible oil does not require processing after contact with the silica-zirconia catalyst.

Embodiment 42. The method of any one of Embodiments 39-41, wherein the initial edible oil has an initial free fatty acid content as measured as a content of oleic acid prior to contact with the silica-zirconia catalyst, and said method changes the initial free fatty acid content, as measured by AOCS Official Method Ca 5a-40, by less than about 20%.

Embodiment 43. The method of any one of Embodiments 39-42, wherein the initial edible oil has an initial free fatty acid content as measured as a content of oleic acid prior to contact with the silica-zirconia catalyst, and said method changes the initial free fatty acid content, as measured by AOCS Official Method Ca 5a-40, by less than about 10%.

Embodiment 44. The method of any one of Embodiments 39-43, wherein the initial edible oil has an initial p-anisidine value (p-AV) prior to contact with the silica-zirconia catalyst, and said method changes the initial p-anisidine value (p-AV) by less than 10 units, as measured by AOCS Official Method Cd 18-90.

Embodiment 45. The method of any one of Embodiments 39-44, wherein the initial edible oil has an initial peroxide value (PV) prior to contact with the silica-zirconia catalyst, and said method changes the initial peroxide value by less than 10 units, as measured by AOCS Official Method Cd 8-53.

Embodiment 46. The method of any one of Embodiments 39-45, wherein the continuous reactor is a packed bed reactor or a CSTR.

It should be understood that although the above-described silica-zirconia catalysts, methods and uses are described as “comprising” one or more components or steps, the above-described silica-zirconia catalysts, methods and uses may “comprise,” “consists of,” or “consist essentially of any of the above-described components or steps of the silica-zirconia catalysts, methods and uses. Consequently, where the present disclosure, or a portion thereof, has been described with an open-ended term such as “comprising,” it should be readily understood that (unless otherwise stated) the description of the present disclosure, or the portion thereof, should also be interpreted to describe the present disclosure, or a portion thereof, using the terms “consisting essentially of” or “consisting of” or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a silica-zirconia catalyst, method and/or use that “comprises” a list of elements (e.g., components or steps) is not necessarily limited to only those elements (or components or steps), but may include other elements (or components or steps) not expressly listed or inherent to the silica-zirconia catalyst, method and/or use.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of or “consisting of” limits only the elements (or components or steps) set forth in that clause: other elements (or components) are not excluded from the claim as a whole.

As used herein, the transitional phrases “consists essentially of” and “consisting essentially of” are used to define silica-zirconia catalysts, methods and/or uses that include materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of.”

While the invention has been described with a limited number of embodiments, these specific embodiments are not intended to limit the scope of the invention as otherwise described and claimed herein. It may be evident to those of ordinary skill in the art upon review of the exemplary embodiments herein that further modifications, equivalents, and variations are possible. All parts and percentages in the examples, as well as in the remainder of the specification, are by weight unless otherwise specified. Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, R_{L}, and an upper limit Ru, is disclosed, any number R falling within the range is specifically disclosed. In particular, the following numbers R within the range are specifically disclosed: R=R_{L}+k (Rᵤ-R_{L}), where k may be from 1% to 100% with a 1% increment, e.g., k is 1%, 2%, 3%, 4%, 5% . . . 50%, 51%, 52% . . . 95%, 96%, 97%, 98%, 99%, or 100%. Moreover, any numerical range represented by any two values of R, as calculated above is also specifically disclosed. Any modifications of the invention, in addition to those shown and described herein, will become apparent to those skilled in the art from the foregoing description and accompanying drawings. Such modifications are intended to fall within the scope of the appended claims.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1-46. (canceled)

47. A method comprising:
contacting an initial composition comprising (i) a triglyceride and (ii) a glycidol, a glycidyl ester, or both glycidol and a glycidyl ester with an effective amount of silica-zirconia catalyst in a continuous reactor to form a treated composition;
wherein:
the silica-zirconia catalyst comprises porous silica particles impregnated with zirconia; and
the concentration of (ii) in the treated composition is less than the concentration of (ii) in the initial composition.

48. The method of claim 47, wherein the continuous reactor is a packed bed reactor, a rotating bed reactor, a continuous stirred tank reactor (CSTR), a plug flow reactor, or a fluidized bed reactor.

49. The method of claim 47, wherein the silica-zirconia catalyst comprises particles having a median particle size of from about 0.1 μm to about 10,000 μm.

50. The method of claim 47, wherein the silica-zirconia catalyst comprises particles having a BET particle surface area of from about 50 m²/g up to about 800 m²/g.

51. The method of claim 47, wherein the silica-zirconia catalyst comprises particles having a pore volume of from about 0.1 cc/g to about 3.0 cc/g as determined by Barrett-Joyner-Halenda (BJH) method.

52. The method of claim 47, wherein the silica-zirconia catalyst exhibits a pH of about 9 or less than 9.

53. The method of claim 47, wherein the contacting step occurs at a temperature of from about 20° C. to about 250° C.

54. The method of claim 47, wherein the contacting step occurs at a gravimetric space velocity of about 1 hr⁻¹ to about 500 hr⁻¹.

55. The method of claim 47, wherein the contacting step comprises mixing the initial composition and the silica-zirconia catalyst in the continuous reactor under inert gas flow or under vacuum.

56. The method of claim 47, wherein the initial composition further comprises an organic solvent comprising heptane, hexane, toluene, diethyl ether, an alcohol, or a combination thereof.

57. The method of claim 47, wherein the initial and treated composition comprises an edible oil comprising soybean oil, palm oil, com oil, canola oil, rapeseed oil, fish oil, algal oil, sunflower oil, olive oil, vegetable oil, plant-derived oil, animal-derived oil, microbial-derived oil, or a combination thereof.

58. The method of claim 47, wherein the glycidyl ester is glycidyl oleate.

59. The method of claim 47, wherein the silica-zirconia catalyst is present in the continuous reactor at a weight percent relative to the amount of the treated composition of less than about 2%.

60. The method of claim 47, wherein the concentration of (ii) in the treated composition is less than 1.0 ppm.

61. A method of treating an initial edible oil to produce a treated edible oil comprising the method of claim 47, wherein the initial and treated compositions are the initial and treated edible oils, respectively.

62. The method of claim 61, wherein the initial edible oil is subjected to a refining, bleaching, and/or-deodorizing (RBD) treatment prior to contact with the silica-zirconia catalyst.

63. The method of claim 61, wherein the treated edible oil does not require processing after contact with the silica-zirconia catalyst.

64. The method of claim 61, wherein the initial edible oil has an initial free fatty acid content as measured as a content of oleic acid prior to contact with the silica-zirconia catalyst, and said method changes the initial free fatty acid content, as measured by AOCS Official Method Ca 5a-40, by less than about 20%.

65. The method of claim 61, wherein the initial edible oil has an initial p-anisidine value (p-AV) prior to contact with the silica-zirconia catalyst, and said method changes the initial p-anisidine value (p-AV) by less than 10 units, as measured by AOCS Official Method Cd 18-90.

66. The method of claim 61, wherein the initial edible oil has an initial peroxide value (PV) prior to contact with the silica-zirconia catalyst, and said method changes the initial peroxide value by less than 10 units, as measured by AOCS Official Method Cd 8-53.
